(19) United States
(12) Patent Application Publication
(10) Pub. No.: US 2022/0097413 A1
(43) Pub. Date: Mar. 31, 2022

(54) Garment Printing Apparatus and Method Thereof for Improving Color Fastness and Color Shadings

(71) Applicants: Wei-Kuang Hou, Taichung City (TW); John Chungteh Pan, Taichung City (TW)

(72) Inventors: Wei-Kuang Hou, Taichung City (TW); John Chungteh Pan, Taichung City (TW)

(21) Appl. No.: 17/039,114

(22) Filed: Sep. 30, 2020

(51) Int. Cl. B41J 3/407; D06P 5/30; D06P 5/12

(52) U.S. Cl. CPC B41J 3/4078; D06P 5/12; D06P 5/30

(57) ABSTRACT

A garment printing apparatus for improving color fastness and color shadings comprises a production line, a loading station, an unloading station, a plural number of intermediate stations, and a pallet. The loading station and the unloading station are respectively disposed on the production line, and the plural number of intermediate stations are disposed therebetween. The plural number of intermediate stations include a pretreatment station for applying a primer coating on a garment, a pattern printing station for making a pixelated pattern print on the garment, and a at least one plasma treatment station. The at least one plasma treatment station is disposed after the loading station and before the pattern printing station for imposing a plasma efficacy on the garment surface before printing a desired pattern on it. The pallet is mobile on the production line for conveying the garment. A garment printing method is provided accordingly.

### BACKGROUND OF THE INVENTION

### 1. Field of the Invention

The present invention relates to making prints on textile fabrics, and more particularly to a garment printing apparatus and a method thereof for improving color fastness and color shadings.

### 2. Description of Related Art

With reference to US Patent Publication No. 20060249039 A1, a conventional digital DTG (Direct-to-Garment) printing system has multiple pallets for garments or cut parts of garments to be placed on and a digital printing apparatus for printing patterns on the garments or the cut parts.

The conventional digital DTG printing system uses inkjet technology to print pixelate patterns on fabric contexture. The fabric contexture of a textile surface is seemingly rugged to the scale of an inkjet droplet. Whereas, the ink droplets could be agglomerated, misaligned, sunk deep into the voids between fabric filaments or absorbed into the fibers by capillary phenomenon, such as that the intentioned print losses its resolution and shading details. Whereas, the textile ink is water-based chemicals that could be incompatible to the surface parity of the textile fiber, such as to fell forming firm bonding between the two.

To overcome the disability of the conventional digital DTG printing system, the present invention provides a garment printing apparatus and a method thereof for improving color fastness and color shadings.

### SUMMARY OF THE INVENTION

The main objective of the present invention is to provide a garment printing apparatus and a method thereof for improving color fastness and color shadings.

The garment printing apparatus of the present invention comprises a production line, a loading station, an unloading station, a plural number of intermediate stations, and a pallet.

The loading station and the unloading station are respectively disposed on the production line, and the plural number of intermediate stations are disposed between the loading and unloading stations.

The plural number of intermediate stations include a pretreatment station for applying primer coating on a textile-piece, a pattern printing station for printing a desired pattern on the textile-piece, and at least one plasma treatment station. The at least one plasma treatment station is disposed after the loading station and before the pattern printing station, to impose specific plasma efficacy on the textile-piece before pattern printing.

The pallet is mobile on the production line for conveying textile-piece from station to station.

The garment printing method of the present invention comprises a preparation step, a pretreatment step, at least one plasma treatment step, and a pattern printing step.

The preparation step comprises preparing a production line and a textile-piece that could be a garment or a cut parts of a garment. The production line has a mobile pallet, a plasma treatment device, and a digital inkjet-printing unit. The plasma treatment apparatus and the digital inkjet-printing unit are disposed on the production line, respectively. The preparation step further comprises laying the textile-piece on the pallet, and conveying the pallet with the textile-piece from station to station, to complete the remaining steps of the present invention.

The pretreatment step comprises applying a primer coating onto the textile-piece. The at least one plasma treatment step comprises imposing specific plasma efficacy on the textile-piece with a plasma generating device. The pattern printing step is performed following completion of the pretreatment step and the at least one plasma treatment step, and comprises printing a pattern on the textile-piece by the digital inkjet-printing unit.

Other objectives, advantages and novel features of the invention will become more apparent from the following detailed descriptions when taken in conjunction with the accompanying drawings.

### BRIEF DESCRIPTION OF THE DRAWINGS

FIG. 1 is a schematic plan view of a garment printing apparatus for improving color fastness in accordance with the present invention;

FIG. 2 is a flow chart of a first embodiment of a garment printing method for improving color fastness in accordance with the present invention; and

FIG. 3 is a flow chart of a second embodiment of a garment printing method for improving color fastness in accordance with the present invention.

### DETAILED DESCRIPTION OF THE PREFERRED EMBODIMENT

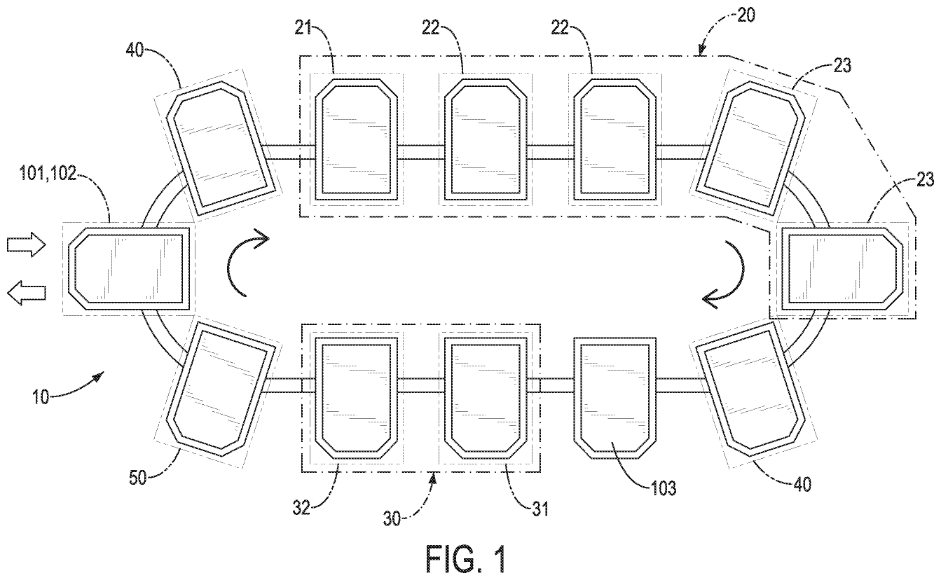

Referring to FIG. 1, a garment printing apparatus for improving color fastness in accordance with the present invention comprises a revolving production line 10, a loading station 101, an unloading station 102, and a plural number of intermediate stations 20, 30, 40, 50. The production line 10 may be in circular or elliptic close loop or may be a carousel type production line. The production line 10 may also be in linear arrangement, where the loading station 101 and the unloading station 102 are disposed at two ends of the production line 10, respectively, and the plural number of intermediate stations 20, 30, 40, 50 are disposed thereby in between. Preferably, when the production line 10 is a carousel type, the loading station 101 and the unloading station 102 coincide at an identical position, as shown in the left end of FIG. 1. The plural number of intermediate stations 20, 30, 40, 50 are arranged in sequential order from the loading station 101, for instance, in a clockwise rotational track, in FIG. 1. p The present invention, as a DTG printing apparatus, is being used to print pixelate patterns directly on garments or cut parts of garments. Therefore, textile-pieces such as garments or cut parts of garments are being laid on conveying pallets on the production line 10 at the loading station 101, and the finishing printed textile-pieces are being collected at the unloading station 102.

Moreover, the garment printing apparatus has a plural number of pallets 103 for transferring the textile-pieces along the production line 10 through all of aforementioned stations 101, 20, 30, 40, 50 and 102. That is to say, each one of the textile-pieces is being laid on one of the plural number of pallets 103, and is transferred by the pallet 103 for being treated through the plural number of intermediate stations 20, 30, 40 and 50. Referring to FIG. 1, the plural number of pallets 103 rotate in clockwise direction.

Further, in reference to FIG. 1, the plural number of intermediate stations 20, 30, 40 and 50 comprise a pretreatment station 20, a pixelate pattern printing station 30, at least one plasma treatment station 40, and a curing station 50. The pretreatment station 20, the pattern printing station 30, and the curing station 50 are arranged in sequential order after the loading station 101.

The pretreatment station 20 is mainly used for applying primer coating to the textile-pieces. The primer coating serves as a bonding enhancing agent to improve color fastness on textile fibers and ligaments. The pretreatment station 20 may have a pretreatment unit 21, at least one flash-cure unit 22, and an optional heat-press unit 23. In a preferred embodiment shown in FIG. 1, the pretreatment station 20 comprises two said flash-cure units 22 and two said heat-press units 23. The pretreatment unit 21 is to apply primer coating on the textile-piece that is being carried by a respective one of the pallets 103. The flash-cure units 22 and the heat-press units 23 are disposed next to the pretreatment unit 21 in sequence to dry and cure the primer coating on the textile-piece. Furthermore, the number of flash-cure units 22 and the heat-press units 23 can be expanded, reduced, or replaced, depending on the printing-process engineering.

The pattern printing station 30 is disposed between the pretreatment station 20 and the unloading station 102, and is capable of printing various patterns selected from a storage library of the present invention or via information network. The pattern printing station 30 can switch between patterns and print on the corresponding textile-pieces specified by job orders, without having to setup or change printing stencils. The pattern printing station 30 may be a digital inkjet printer comprising an underlay printing unit 31 and a color-print unit 32.

The underlay printing unit 31 can print a white underlay pattern on the textile-piece, especially for dark-color fabrics. White speckles of textile ink are being laid out by digital inkjet-printing unit in pixelate pattern on top of the primer coating done by station 20. The white underlay pattern may not be necessary if the textile-piece is a white fabrics or light-color fabrics. The underlay printing unit 31 may thus be omitted or removed from the production line, if say in such circumstances.

The color-print unit 32 is placed next to the underlay printing unit 31. The color-print unit 32 can make a photo-like pixelated prints composed by multiple colors of textile ink speckles. A typical embodiment of the color-print unit 32 may comprise multiple colors of inks. A typical embodiment of the color-print unit 32 comprises, for example, CMYK (Cyan, Magenta, Yellow and Black) four-color printing capability. With digital compositions of pixelated four-color prints, the present art of the invention has advantages over traditional stencil printing in such as picture resolutions, levels of color-shadings, and the convenience of altering printing patterns. The digital printing device in the present invention is the same as that of the prior art. However, poor color fastness or dull color shadings resulting from a non-sizing pretreatment may be resolved through the following device provided in the present invention.

The at least one plasma treatment station 40 is disposed on the production line 10 between the loading station 101 and the pattern printing station 30 for imposing specific plasma efficacy on the textile-pieces before patter printing. When the garment printing apparatus has only one said plasma treatment station 40, the plasma treatment station 40 is disposed in between the pretreatment station 20 and the pattern printing station 30. Plasma flow is thereby swept through the textile-piece to condition the surface that has already coated with pretreatment primer.

Furthermore, the ions in the plasma flow impinge on the fabric contexture to create a temporary isotropic surface condition which would prevent the textile ink droplets exerted by the printing station 30, later, from being agglomerated, misaligned, sunk deep into the voids between fabric filaments or absorbed into the fibers by capillary phenomenon. Unlike traditional textile dying, digital DTG printing uses pigment inks, thus eliminating the polluting processes of steaming and desizing. Yet, color pigments in the inks are nanoparticles, that can only be visible if it is being affixed onto the exterior surface of the textile-piece. If, however, the nano-pigments are being absorbed into the deeper core of a fiber filament, then, not only the color becomes dull in appearance, but also promotes a phenomenon call color-crossing. Color-crossing is due to wet ink speckles of different colors diffused into each other before the curing process by the curing station 50 could happen, and the diffused, murky ink speckles destroys the definitions and details of a desired pixelate picture or pattern. Therefore, plasma treatment given by the at least one plasma treatment station 40 improves color chroma and shading details of a print done by the pattern printing station 30. In addition, specific gas plasma, exerted by the at least one plasma treatment station 40, can stimulate or activate ionic bonding among the fabric filaments of the textile-piece, the pretreatment agent, exerted by the pretreatment station 20, and the binder compound in the textile inks, exerted by the pattern printing station 30. After curing by the curing station 50, the adhesion converted into stable crosslinking bonding, hence improves the color fastness.

Referring to FIG. 1, when the garment printing apparatus has two said plasma treatment stations 40, one of the two plasma treatment stations 40 is disposed between the pretreatment station 20 and the pattern printing station 30, and the other one of the two plasma treatment stations 40 is disposed between the loading station 101 and the pretreatment station 20. Therefore, plasma treatment is not only exerted on the primer coating of the textile-pieces, but is also exerted directly on the naked filaments of the textile-piece, before primer pretreatment. In such way, the bonding strength among the fabric filaments of the textile-piece and the primer may also be improved.

Moreover, in prior art, specific gas plasma is known to be used for conditioning the hydrophobicity or hydrophilicity of a textile. Incidentally, the pretreatment agent and the pigment inks are water-based coatings. Furthermore, the method to generate plasma flow is a prior art, comprises a device known as APPJ (Atmospherically Pressure Plasma Jet), or could also be a corona discharge equipment, whichever is effective in creating an ionic efficacy on the textile-piece.

The curing station 50 is disposed next to the pattern printing station 30, before the unloading station 102. When the desired pattern is finished printing on the textile-piece, the corresponding pallet 103 carries the textile-piece to the next curing station 50 for thermofixation or UV curing on prints. Once the pigment-inks on the print are cured, the pallet 103, then, carries the textile-piece to the unloading station 102 for collection. The curing station 50 may comprise another flash-cure unit, as well as may comprise an UV-lamp unit, depending on the ink chemistry.

Accordingly, in reference to FIGS. 1, 2 and 3, a garment printing method for improving color fastness in accordance with the present invention comprises a preparation step, a pretreatment step, at least one plasma treatment step, a pattern printing step, a curing step, and a collection step. In the preparation step, a textile-piece is being loaded to a production line 10. The production line 10 comprises at least one pallet 103 and devices 21, 22, 23, 31, 32, 40, 50 for the pretreatment step, the plasma treatment step, the pattern printing step, and the curing step disposed on the production line 10.

The preparation step comprises laying a textile-piece on a respective one of said conveying pallets 103, and then transporting the pallet on production line 10, from station to station, to complete the remaining steps of the present invented method.

The pretreatment step comprises deploying a wet primer coating onto the textile-piece, and then drying the coating. The primer is normally water-based compounds that promotes chemical polarity on the surface of the textile-piece, and thus enhances the bonding strength between the textile and the inks to be applied. The drying of the pretreatment primer is to simply remove the excessive water from the textile, and to facilitate the quality of the digital pixelate printing comes later by the printing step.

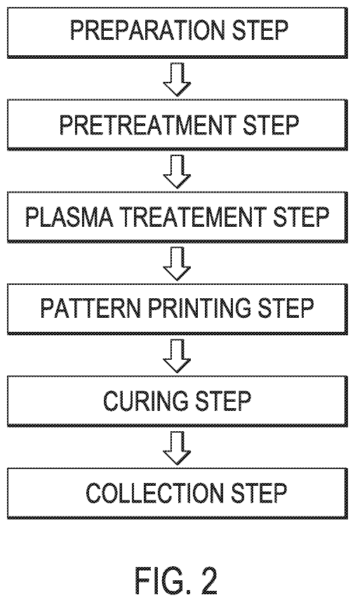

Referring to FIG. 2, a first embodiment of the garment printing method in accordance with the present invention comprises only one said plasma treatment step. The plasma treatment step is in subsequence to the pretreatment step and is prior to the pattern printing step. During the plasma treatment step, plasma flow is being deployed by a plasma generating device to sweep the surface of a textile-piece coated with primer.

Next to the plasma treatment step is followed by the pattern printing step that comprises a digital inkjet device to make prints of desired patterns on the textile-piece. In case of dark garment fabrics, an optional white underlay can be printed before the color print. whereas, the white underlay can mask the dark fabrics and provide a blank background in contrast for the color inks to be laid on. Hence, the color pigments from the color inks can be shown off more vividly against the white pigments from the white ink. Nonetheless, if the garment fabrics is in light color, the underlay print can be omitted.

However, in case the plasma treatment step of the present invention has been skipped, the white or color ink droplets could be drawn further into the fabric core and away from the textile surface, which would, then, reduce the masking effect to cover the background color of the fabrics itself. In consequence, the color print on garment could become dull in appearance. Furthermore, the plasma treatment of the present invention can excite the valence state of a textile surface, hence promote a stronger bonding between the textile fiber and the primer or the ink molecules. As a result, the color fastness and shadings of the printing on a garment is improved with the present invented method.

The next is curing step after the printing step, before the textile-piece could finally be unloaded in the collection step. The curing step uses a thermofixation process or an UV photo-chemistry process to cause the ink binder to be solidified and fix the ink colorants firmly to the textile-piece. Post-curing step, the garment printing job is completed and the textile-piece is sent to the unloading station for collection or for further assembly.

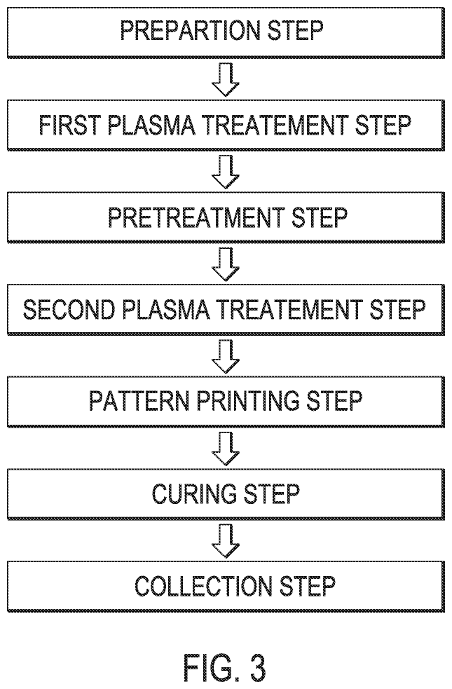

Referring to FIG. 3, a second embodiment of a garment printing method in accordance with the present invention differs from the first embodiment of the present invention in that: the second embodiment of the method comprises two said plasma treatment steps, respectively referred to as a first plasma treatment step and a second plasma treatment step.

The first plasma treatment step is performed before the pretreatment step, and after the preparation step. In the first plasma treatment step, the plasma flow is swept through the exposed fiber filaments of the textile-piece directly. The bombardment of energetic ions from the plasma flow agitate the valence state on the textile surface, and make the surface be more coherent with the pretreatment prime to be applied. In a typical case, the pretreatment primer is water-base agent. The plasma treatment can condition the textile fibers to be properly hydrophilic to ensure a uniform wetting of primer coating on the textile-piece.

The second plasma treatment step is performed after the pretreatment step and before the pattern printing step. The efficacy of the second plasma treatment step is the same as those described in the context of the first embodiment by the present invention.

With the aforementioned technology characteristics, the present invention, a garment printing apparatus and the method thereof for improving color fastness and shadings, has the following advancement merits:

1. With plasma treatment, the wetting characteristics of primer coating and inkjet printing on textile surface are improved, thus the amount of primer or inks used are much less than the conventional printing method.

2. With plasma treatment, the valence state is agitated on the textile surface, promoting stronger bonding between the textile fibers and the primer coating, as well as the textile inks. Hence, the color fastness is improved.

3. With plasma treatment, the colorants from the textile inks are concentrated to the exterior surface of the textile filaments, thus improves the color shadings of a desired prints and reaches a higher print quality.

Even though numerous characteristics and advantages of the present invention have been set forth in the foregoing descriptions, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A garment printing apparatus for improving color fastness and shadings, and the garment printing apparatus comprising:
a production line;
a loading station disposed on the production line;
an unloading station disposed on the production line;
a plural number of intermediate stations disposed on the production line between the loading station and the unloading station, and including
a pretreatment station for applying primer coating to a textile-piece;
a pattern printing station being a digital inkjet printer for printing a desired pattern on the textile-piece; and
at least one plasma treatment station disposed between the loading station and the pattern printing station for imposing specific plasma efficacy on the textile-piece before pattern printing; and
a pallet being mobile on the production line for conveying the textile-piece.

2. The garment printing apparatus for improving color fastness and shadings as claimed in claim 1, wherein the production line is a carousel type, and the loading station is coincided with the unloading station at an identical position.

3. The garment printing apparatus for improving color fastness and shadings as claimed in claim 1, wherein the at least one plasma station is disposed between the pretreatment station and the pattern printing station.

4. The garment printing apparatus for improving color fastness and shadings as claimed in claim 2, wherein the at least one plasma station is disposed between the pretreatment station and the pattern printing station.

5. The garment printing apparatus for improving color fastness and shadings as claimed in claim 1, wherein
the garment printing apparatus has two said plasma treatment stations;
one of the two plasma treatment stations is disposed between the pretreatment station and the pattern printing station, and the other plasma treatment station is disposed between the loading station and the pretreatment station.

6. The garment printing apparatus for improving color fastness and shadings as claimed in claim 2, wherein
the garment printing apparatus has two said plasma treatment stations;
one of the two plasma treatment stations is disposed between the pretreatment station and the pattern printing station, and the other plasma treatment station is disposed between the loading station and the pretreatment station.

7. The garment printing apparatus for improving color fastness and shadings as claimed in claim 1, wherein the pretreatment station comprises
a pretreatment unit for applying primer coating on the textile-piece;
at least one flash-cure unit disposed next to the pretreatment unit; and
at least one heat-press unit disposed next to the at least one flash-cure unit.

8. The garment printing apparatus for improving color fastness and shadings as claimed in claim 1, wherein the pattern printing station has
an underlay printing unit being able to print a white underlay pattern on the textile-piece; and
a color-print unit disposed next to the underlay printing unit, and being able to print pixelated color patterns on-demand to designated textile-pieces in queue.

9. A garment printing method for improving color fastness and shadings, and the garment printing method comprising:
a preparation step comprising
preparing a production line, and the production line having
a pallet being mobile on the production line;
a plasma treatment device disposed on the production line; and
a digital inkjet-printing unit disposed on the production line;
preparing a textile-piece being a garment or a piece of cut parts of a garment;
laying the textile-piece onto the pallet; and
conveying the pallet with the textile-piece for the remaining steps of the garment printing method;
a pretreatment step comprising
applying a primer coating onto the textile-piece;
at least one plasma treatment step comprising
imposing specific plasma efficacy on the textile-piece with a plasma generating device; and
a pattern printing step is performed after completion of the pretreatment step and the at least one plasma treatment step, and comprising
printing a pattern on the textile-piece by a digital inkjet-printing unit.

10. The garment printing method for improving color fastness and shadings as claimed in claim 9, wherein the at least one plasma treatment step is performed after the pretreatment step and before the pattern printing step.

11. The garment printing method for improving color fastness and shadings as claimed in claim 9, wherein
the method comprises two said plasma treatment steps comprises
a first plasma treatment step that is performed after the preparation step and before the pretreatment step; and
a second plasma treatment step that is performed after the pretreatment step and before the pattern printing step.
